(19) United States
(12) Patent Application Publication
(10) Pub. No.: US 2024/0003082 A1
(43) Pub. Date: Jan. 4, 2024

(54) THERMAL TRANSFER METHOD AND SYSTEM FOR FABRICS AND RELATED FABRICS AND ITEMS

(71) Applicants: Guangzhou Xunjie Digital Technology Co., Ltd., Guangzhou City (CN); Guangzhou Xiyin International Import and Export Co., Ltd., Guangzhou City (CN)

(72) Inventors: Xinlou Qu, Guangzhou City (CN); Yong Deng, Guangzhou City (CN); Zhipeng Zhong, Guangzhou City (CN); Wenjie Fang, Guangzhou City (CN); Bei Li, Guangzhou City (CN)

(21) Appl. No.: 18/346,706

(22) Filed: Jul. 3, 2023

(30) Foreign Application Priority Data
Jul. 4, 2022 (CN) 202210779884

(51) Int. Cl. D06P 5/22; D06P 5/28; D06P 5/20; D06P 3/24; D06P 1/653

(52) U.S. Cl. CPC D06P 5/22; D06P 5/004; D06P 5/2072; D06P 3/24; D06P 1/6536

(57) ABSTRACT

A thermal transfer method for fabrics is disclosed, comprising the following steps: 1) modifying a fabric with a modifier; 2) attaching a heat transfer paper having a pattern to a modified fabric, and then performing a thermal pressure treatment. The thermal transfer method for fabrics as disclosed herein has simple steps, low cost, and readily available raw materials of the modifier, and is suitable for large-scale production. The fabric prepared by the thermal transfer method has complete pattern, bright color, uniform coloring, good color fastness, washing resistance, soft material and a good feeling on the skin.

### CROSS-REFERENCE TO RELATED APPLICATIONS

The present application claims priority to Chinese Patent Application No. CN 202210779884 filed on Jul. 4, 2022, the contents of which are incorporated herein by reference in its entirety.

### TECHNICAL FIELD

The present disclosure relates to the technical field of transfer printing, and in particular to a thermal transfer method and systems for fabrics, and related fabrics, and related fabrics and items.

### BACKGROUND

Certain fabrics have a chemical composition and structural features that make the related dying problematic. In particular, fabric containing terminal amino groups and does not contain benzene typically require adjustment in related dyeing and printing processes. For example, nylon fabrics are polyamide fibers, common nylon fabrics are nylon-6 and nylon-66; its chemical name is adipic acid-hexanediamine polycondensate or polycaprolactam, and its molecular structure has amide groups and terminal amino groups, and does not contain groups such as benzene rings. Accordingly, the use of certain dyes is problematic and often involves extra steps in the printing process to improve color fastness as understood by a skilled person.

Despite attempts to improve the existing process, a fast-printing process suitable for nylon fabrics and other fabrics with terminal amino groups which require extra steps for the related dyeing can provide good color distribution and color fastness color brilliance as well as ensuring a quality of the work product remains challenging.

### SUMMARY

Provided herein is a thermal transfer method and system and related fabric and fabric items which are particularly suitable for processing and printing of fabrics such as a nylon which have a molecular structure not including a benzene ring and presenting terminal amino groups.

The thermal transfer method and system and related fabric and fabric items of the present disclosure are based on the use of a small molecule modifier containing a carboxylic acid group, a benzene ring and a naphthalene ring, in order to pre-modify a fabric containing terminal amino groups under acidic conditions; during the modification process, the carboxylic acid groups in the molecular structure of the modifier are firmly combined with the amino groups in the fabric in the form of ionic bonds, the benzene ring in the molecular structure of the modifier is introduced into the fabric as a dye site of the disperse dye, and thus the modified fabric is ready to be dyed by the disperse dye. At the same time, since the modifier is a small molecule, it has no effect on the hand feeling of the fabric.

Accordingly, according to a first aspect a thermal transfer method for fabrics is described. The method comprises providing a fabric having a molecular structure not comprising a benzene ring and presenting amino groups and contacting the fabric with a modifying solution comprising a modifier selected from the group consisting of benzoic acid, naphthoic acid and a compound represented by Formula (I);

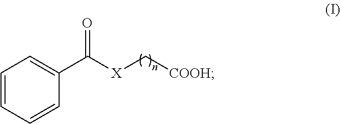

in which X is selected from O or NH, and n is a positive integer selected from 1-10, in the method the contacting is performed to obtain modified fabric before performing a thermal pressure treatment.

According to a second aspect a thermal transfer system is described for thermal treatment of fabrics. The system comprises a fabric having a molecular structure which does not include benzene and presents terminal amino groups, and a modifier selected from the group consisting of benzoic acid, naphthoic acid and a compound represented by Formula (I);

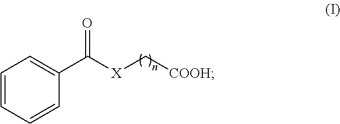

in which X is selected from O or NH, and n is a positive integer selected from 1-10. In the system of the disclosure the modifier can be comprised in a solution and the system can further comprises reagents and devices to perform a thermal pressure treatment.

According to a third aspect a printed fabric is described. The printed fabric is a fabric that does not include benzene and presents terminal amino groups and is obtained by the thermal transfer method of the present disclosure following contacting with a modifier of the present disclosure.

According to a fourth aspect a fabric item and in particular a clothing item is described which comprises a printed fabric of the present disclosure.

The thermal transfer method and system and related fabric and fabric items allow in several embodiments to overcome the problems of the fabric after thermal transfer lacking washing resistance and color fastness, of existing methods.

The thermal transfer method and system and related fabric and fabric items allow in several embodiments to print fabrics whose molecular structure does not contain a benzene ring and present amino terminal group without the need of use of acid dyes or reactive dyes which are often used by current methods for dyeing or printing.

The thermal transfer method and system and related fabric and fabric items allow in several embodiments to print fabrics whose molecular structure does not contain a benzene ring and present amino terminal group to obtain an improved the fastness of dyeing or printing with disperse dyes compared to existing methods.

The thermal transfer method and system and related fabric and fabric items allow in several embodiments to print fabrics whose molecular structure does not contain a benzene ring and present amino terminal group without the need to wash the color with steamed water after dyeing and printing, and then remove the floating color by washing and soaping, so as to improve the color fastness.

The thermal transfer method and system and related fabric and fabric items allow in several embodiments to print fabrics whose molecular structure does not contain a benzene ring and present amino terminal group with more efficient process time, lower energy consumption, and lower water consumption, as well as with simpler process also resulting in reduced staining and higher yields compared to existing methods.

The thermal transfer methods and herein described and related systems, fabric, and fabric items herein described can be used in connection with applications wherein coloration of textile material is desired without limiting to a particular industry. An ordinary skilled person in the art would be able to identify additional applications and industry upon reading of the present disclosure.

The details of one or more embodiments of the disclosure are set forth in the accompanying drawings and the description below. Other features, objects, and advantages will be apparent from the description and drawings, and from the claims

### BRIEF DESCRIPTION OF DRAWINGS

The accompanying drawings, which are incorporated into and constitute a part of this specification, illustrate one or more embodiments of the present disclosure and, together with the detailed description and the examples, serve to explain the principles and implementations of the disclosure.

FIG. 1 shows a diagram of a thermally transferred sample of a nylon fabric according to Example 1.

FIG. 2 shows a diagram of a thermally transferred sample of a nylon fabric according to Example 2.

FIG. 3 shows a diagram of a thermally transferred sample of a nylon fabric according to Example 3.

FIG. 4 shows a diagram of a thermally transferred sample of a nylon fabric according to Example 4.

FIG. 5 shows a diagram of a thermally transferred sample of a nylon fabric according to Example 5.

FIG. 6 shows a diagram of a thermally transferred sample of a nylon fabric according to Example 6.

FIG. 7 shows a diagram of a thermally transferred sample of a nylon fabric according to Example 7.

FIG. 8 shows a diagram of a thermally transferred sample of a nylon fabric according to Example 8.

FIG. 9 shows a diagram of a thermally transferred sample of a nylon fabric according to Example 9.

FIG. 10 shows a diagram of a thermally transferred sample of a nylon fabric according to Comparative Example 1.

FIGS. 11A and 11B show example clothing with printed designs and/or patterns from thermal transfer.

### DETAILED DESCRIPTION

Provided herein is a thermal transfer method and system and related fabric and fabric items which are particularly suitable for processing and printing of fabrics such as a nylon which have a molecular structure not including a benzene ring and presenting terminal amino groups.

The thermal transfer is a sort of fast printing process recognized in the art, which has the advantages of short process, bright color, high fastness, and no need to wash with water. However, due to the limited adsorption capacity of certain fabrics to disperse dyes, the use of thermal transfer on those fabrics can result in a lightening of the color and a poor fastness.

Processes directed to improve color brightness and fastness however can result in a fabric that does not have good washing resistance after printing and has limited color fastness due to the high-water solubility of surfactants used. Additional processes use modifiers which have a negative effect on the hand feeling of nylon fabrics and affect wearing properties of nylon fabrics adversely. Those issues are in particular known for fabric such as nylon which have a molecular structure lacking a benzene ring and presenting amino groups, as well as for various fiber-based materials, including fibers, yarns, filaments, threads, different fabric types, and additional fiber-based material identifiable by an ordinary skilled person in the art. Fabrics in the sense of the disclosure comprise consumer textiles such as clothing, where the primary purpose of the fabric is comfort and/or style. Fabrics in the sense of the disclosure also comprise technical textiles such as geotextile, industrial textile, medical textiles where functionality is the primary purpose of the fabric. Exemplary fabrics comprise woven fabrics, knitted fabrics, non-woven fabrics and additional fabrics as identifiable by an ordinary skilled person in the art. Fabrics in the sense of the disclosure comprise natural fabric and synthetic fibers or mixtures thereof. [1] [2]

The term “fiber” or “fiber material” as used herein indicates a natural or artificial substance that is significantly longer than it is wide. Fibers are often used in the manufacture of other materials. Synthetic fibers can often be produced very cheaply and in large amounts compared to natural fibers, but for clothing natural fibers can give some benefits, such as comfort, over their synthetic counterparts. [3]

Fiber material can take various forms, typically the form of a yarn is a long continuous length of interlocked fibers, used in sewing, crocheting, knitting, weaving, embroidery, ropemaking, and the production of textiles. Additional fabric materials comprise threads and embroidery threads, as well as additional material which can in some instances be finished with wax or other lubricants to withstand the stresses involved in sewing. [4]

Exemplary fiber material comprises cotton, rayon, wool, and silk and additional fiber materials as identifiable by a skilled person.

The term “natural fiber” as used herein indicated fibers that are produced by geological processes, or from the bodies of plants or animals. Natural fibers comprise plant fibers and animal fibers depending on the source of the fiber. Exemplary plant fibers include seed fibers collected from the seeds of various plants (e.g. cotton), fruit fibers collected from the fruit of the plant, (e.g., coconut fiber) and stalk fiber from the stalks of plants, (e.g. straws of wheat, rice, barley, bamboo and straw). Exemplary animal fibers comprise animal hair (wool or hairs): taken from animals or hairy mammals, e.g. sheep's wool, goat hair (cashmere, mohair), alpaca hair, horse hair, etc. and silk fiber: fiber secreted by glands (often located near the mouth) of insects during the preparation of cocoons. [5]

The term “synthetic fiber” as used herein indicates fibers made by humans through chemical synthesis, as opposed to natural fibers that are directly derived from living organisms. Exemplary synthetic fibers include: Nylon Modacrylic Olefin Acrylic Polyester, as well as Rayon (1894) artificial silk, Spandex, Vinalon, Aramids and additional synthetic fibers identifiable by a skilled person. [6]

In methods and systems of the disclosure the fabric treated is a fabric having a molecular structure lacking a benzene ring and including amino groups. Exemplary fabrics comprise: nylon fabric, and polyester-cotton blended fabric.

Preferably, a fiber of the fabric comprises a fiber containing terminal amino groups; more preferably, the fiber of the fabric comprises at least one of a protein fiber and a nylon fiber; much more preferably, the fiber of the fabric comprises a nylon fiber.

In thermal transfer method in the sense of the disclosure a fabric with the above features is contacted with a modifier selected from the group consisting of benzoic acid, naphthoic acid and a compound represented by Formula (I);

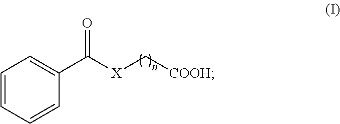

in which X is selected from O or NH, and n is a positive integer selected from 1-10.

In some embodiments, the modifier is selected from the group consisting of benzoic acid, naphthoic acid and a compound represented by Formula (I);

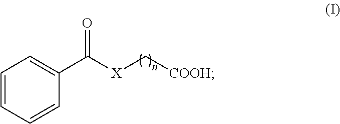

in Formula (I), X is selected from O or NH, and n is a positive integer selected from 1-10.

Preferably, in Formula (I), X is selected from O or NH, and n is a positive integer selected from 1, 2, 3 and 7.

Preferably, the modifier includes at least one of the compounds shown in the following structures:

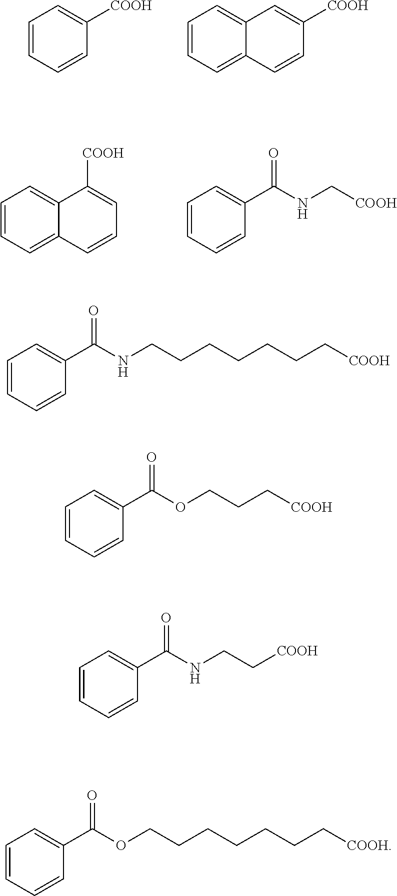

In preferred embodiments the modifier is within a modifier solution with a suitable solvent.

Preferably, a solvent for the modifier is selected from the group consisting of water, ethanol, ethyl acetate, N,N-dimethylformamide, and N,N-dimethylacetamide or any combination thereof; more preferably, the solvent for the modifier is water. A modifying solution is a mixture of a modifier and a solvent therefor.

Preferably, an amount of the modifier is 5% o.m.f. (on mass of fabric) to 40% o.m.f; more preferably, the amount of the modifier is 10% o.m.f to 30% o.m.f (on mass of fabric).

Preferably, a bath ratio of the modifying solution is 1:(5-20), i.e. from 1:5 to 1:20; more preferably, the bath ratio of the modifying solution is 1:(7-15). As used herein, “bath ratio” refers to the ratio of weighted concentrations of modifying solution to solvent.

Preferably, a pH value of the modifying solution is 3-6; more preferably, the pH value of the modifying solution is 4-5.

In some embodiments a thermal transfer method for fabrics, comprises the following steps:
a) modifying a fabric with a modifier;
b) attaching a heat transfer paper having a pattern to a modified fabric in step a), and then performing a thermal pressure treatment to obtain a thermally transferred modified fabric.

The wording “thermal transfer” as used herein indicates a type of fast printing process identifiable by a skilled person, which has the advantages of short process, bright color, high fastness, and no need to wash with water.

The wording “thermal transfer paper” as used herein indicates a thin piece of paper, usually coated with wax and pigment, used for performing a thermal transfer of a pattern to a fabric. Following the printing of a pattern to the transfer paper, the pattern can be then transferred onto a fabric by a heat press, as understood by a skilled person. [7]

A thermal transfer method according to the present disclosure comprises contacting a fabric with the modifier, before thermally transferring an ink or dye to the fabric from a thermal transfer paper previously printed with an ink or a dye, as understood by a skilled person upon reading of the present disclosure

The term “ink” as used herein indicates a gel, sol, or solution that contains at least one colorant, such as a dye or pigment, and is used to color a surface to produce an image, text, or design. Ink formulas vary, but commonly involve two components, Colorants and Vehicles. Suitable colorants comprise pigments and dye. The vehicles usually comprise binders. Inks in the sense of the disclosure can be in an aqueous liquid paste and/or powder form depending on the colorant and vehicle used as understood by a person with ordinary skill in the art. [8]

The term “dye” as used herein indicates a colored substance that chemically bonds to the substrate to which it is being applied. This property distinguishes dyes from pigments which do not chemically bind to the material they color. A dye in the sense of the disclosure is generally applied in an aqueous solution, and may require a mordant to improve the fastness of the dye on the fiber. Dyes are usually soluble in water whereas pigments are insoluble. Some dyes can be rendered insoluble with the addition of salt to produce a fake pigment as understood by a person with ordinary skill in the art. [9]

Preferably, a temperature of the modifying a fabric with a modifier is 50° C. to 120° C.; more preferably, the temperature of the modifying is 80° C. to 110° C.; much more preferably, the temperature of the modifying is 90° C. to 105° C. As used herein, a modifying refers to the process of contacting a fabric with a modifying solution to obtain a modified fabric wherein the modifier is covalently bonded, electrostatically, or physically attached to the fabric.

Preferably, a time of the modifying a fabric with a modifier is 20 mins to 100 mins; more preferably, the time of the modifying is 40 mins to 70 mins.

Preferably, the modifying a fabric with a modifier further comprises a step of washing the modified fabric.

Preferably, a number of times of the washing is 1-2.

Preferably, a temperature of the washing is 50° C. to 100° C.

Preferably, a solvent for the washing is water.

Preferably, the modifying further comprises a step of drying the modified fabric.

Preferably, a temperature of the drying is 50° C. to 100° C.

Preferably, the method of the thermal pressure treatment is performed by a hot-pressing plate or a hot roller; more preferably, the method of the thermal pressure treatment is performed by a hot-pressing plate.

Preferably, a pressure of the thermal pressure treatment is 0.1 Mpa to 5 Mpa; more preferably, the pressure of the thermal pressure treatment is 0.15 Mpa to 2 Mpa.

Preferably, the method of the thermal pressure treatment is performed by using a hot-pressing plate or a hot roller, so that the dye of the thermal transfer paper having the pattern is sublimated onto the modified polyester-cotton blended fabric.

Preferably, a temperature of the thermal pressure treatment is 200° C. to 230° C.; more preferably, the temperature of the thermal pressure treatment is 210° C. to 230° C.

Preferably, a time of the thermal pressure treatment is 10 s to 30 s; more preferably, the time of the thermal pressure treatment is 15 s to 25 s.

Preferably, before the step of modifying, it also includes a step of printing the designed pattern on the thermal transfer paper.

Preferably, a gram weight of the thermal transfer paper is 25 g/m 2 to 35 g/m 2.

Preferably, the nylon fabric is selected from at least one of nylon-6 and nylon-66.

A second aspect of the present invention provides use of the thermal transfer method according to the first aspect of the present disclosure in fabric transfer printing.

Described herein is also a thermal transfer system for thermal treatment of fabrics. The system comprises a fabric having a molecular structure which does not include benzene and presents terminal amino groups, and a modifier selected from the group consisting of benzoic acid, naphthoic acid and a compound represented by Formula (I);

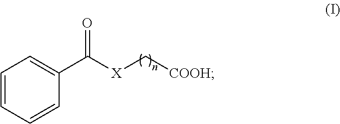

in which X is selected from O or NH, and n is a positive integer selected from 1-10. In the system of the disclosure the modifier can be comprised in a solution and the system can further comprises reagents and devices to perform a thermal pressure treatment.

In particular in some embodiments, a thermal transfer system of the present disclosure comprise at least one modifier herein described in combination with one of one or more inks, one of one or more dyes, one or more thermal transfer papers to be printed and/or pre-printed, and one or more fabrics having a structure without a benzene moiety and including amino groups. In the thermal transfer system of the present disclosure the components of the system are comprised in combination, for use in performing thermal transfer of the ink or dye to the fabric in accordance with anyone of the methods of the disclosure, as will be understood by a skilled person.

In some embodiments, the thermal transfer system of the present disclosure, can comprise the one or more modifiers, inks and/or dyes in pre-dosed composition, as will be understood by a skilled person upon reading of the present disclosure.

A printed fabric is described. The printed fabric is a fabric that does not include benzene and presents terminal amino groups and is obtained by the thermal transfer method of the present disclosure following contacting with a modifier of the present disclosure.

In some embodiments of the disclosure a printed fabric is described prepared by the thermal transfer method according to the disclosure.

Preferably, the printed fabric is a printed nylon fabric.

In an additional aspect, a fabric item of the present disclosure comprises a fabric obtained with the method and/or system of the disclosure. The wording “fabric item” in the sense of the disclosure indicates an object that comprises fabric, such as drapes, towels, tablecloth, kitchen cloth, blankets and garments for humans or pets as well as pillows and further objects comprising fabric identifiable by a skilled person.

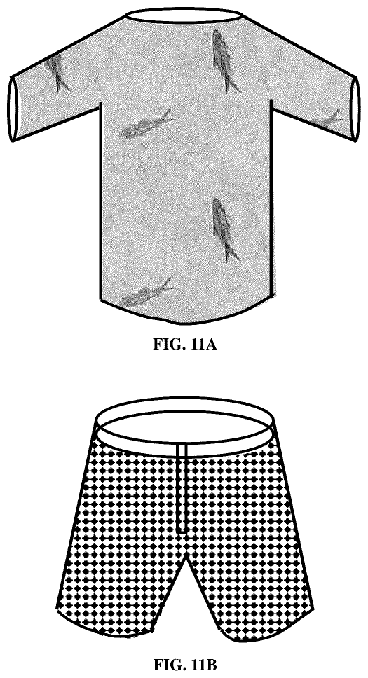

In particular, in some embodiments the fabric item can be a clothing item such as the exemplary garments schematically illustrated in FIGS. 11A and 11B. FIG. 11A shows an example shirt with a thermal transferred decorative pattern. FIG. 11B shows an example pair of shorts with a thermal transferred repeating pattern—in this example, a repeating geometric pattern.

The beneficial effects of the present invention include:

The thermal transfer method for fabrics described in the present disclosure has simple steps, low cost, and readily available raw materials of the modifier, and is suitable for large-scale production. The fabric prepared by the thermal transfer method provided by the present invention has complete pattern, bright color, uniform coloring, good color fastness, washing resistance, soft material and a good feeling on the skin.

### DESCRIPTION OF EXEMPLARY EMBODIMENTS

In order to make the purpose, technical solutions and technical effects of the thermal transfer method and system and related fabric and fabric items of the present disclosure clearer, the thermal transfer method and system and related fabric and fabric items of the present disclosure will be further described in detail below with reference to the specific embodiments. It should be understood that the specific embodiments described in this specification are only for illustrating the thermal transfer method and system and related fabric and fabric items of the present disclosure, and should not be limiting.

In particular specific implementation of the thermal transfer method and system and related fabric and fabric items of the present disclosure will be further described below with reference to examples, but the implementation and protection of the thermal transfer method and system and related fabric and fabric items of the present disclosure are not limited thereto. It should be pointed out that, if there are any processes which are not described in detail below, those skilled in the art can implement or understand them in view of their knowledge and the indications of the present disclosure. The used reagents or instruments that do not indicate the manufacturer are regarded as conventional products which can be purchased in the market.

The fabrics used in the examples are all nylon fabrics, and the solution is described below by taking nylon fabrics as examples.

### Example 1

The thermal transfer steps for the nylon fabric in this example are as follows:
1) printing a designed pattern on a thermal transfer paper with a digital printer, so as to obtain the thermal transfer paper having the pattern;
2) weighing 1 g benzoic acid and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.
3) attaching the heat transfer paper having the pattern in step 1) to the modified nylon fabric in step 2), and then thermally transferring under the conditions of a temperature of 220° C., a time of 20 s and a transfer printing pressure of 0.3 MPa, so as to obtain a blended fabric after thermal transfer.

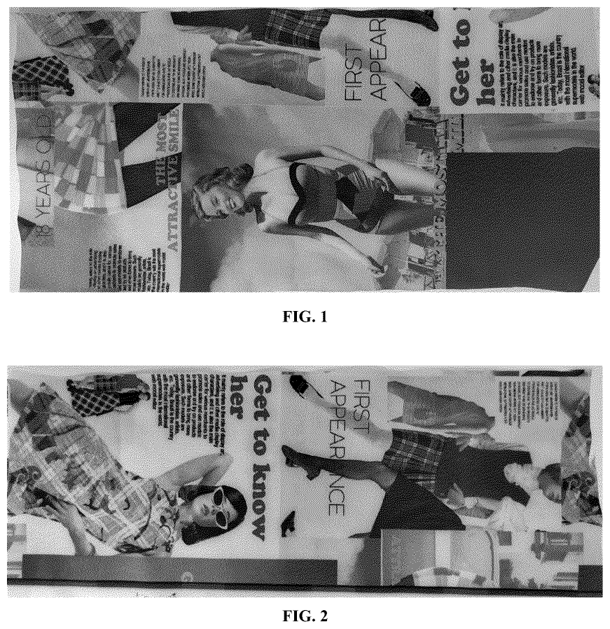

In this case, the thermal transfer is performed by using a hot-pressing plate, so that the dye of the thermal transfer paper having the pattern is sublimated onto the treated polyester-cotton blended fabric. FIG. 1 is a diagram of a thermally transferred sample of a nylon fabric according to Example 1.

### Example 2

The thermal transfer steps for the nylon fabric in this example are as follows:
1) printing a designed pattern on a thermal transfer paper with a digital printer, so as to obtain the thermal transfer paper having the pattern;
2) weighing 1 g 1-naphthoic acid and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.
3) attaching the heat transfer paper having the pattern in step 1) to the modified nylon fabric in step 2), and then thermally transferring under the conditions of a temperature of 220° C., a time of 20 s and a transfer printing pressure of 0.3 MPa, so as to obtain a blended fabric after thermal transfer;

In this case, the thermal transfer is performed by using a hot-pressing plate, so that the dye of the thermal transfer paper having the pattern is sublimated onto the treated polyester-cotton blended fabric. FIG. 2 is a diagram of a thermally transferred sample of a nylon fabric according to Example 2.

### Example 3

The thermal transfer steps for the nylon fabric in this example are as follows:
1) printing a designed pattern on a thermal transfer paper with a digital printer, so as to obtain the thermal transfer paper having the pattern;
2) weighing 2 g 1-naphthoic acid and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.
3) attaching the heat transfer paper having the pattern in step 1) to the modified nylon fabric in step 2), and then thermally transferring under the conditions of a temperature of 220° C., a time of 20 s and a transfer printing pressure of 0.4 MPa, so as to obtain a blended fabric after thermal transfer.

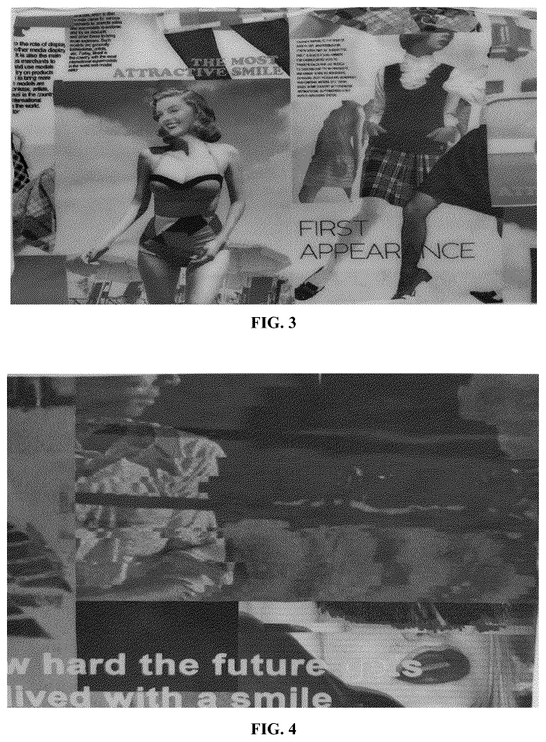

In this case, the thermal transfer is performed by using a hot-pressing plate, so that the dye of the thermal transfer paper having the pattern is sublimated onto the treated polyester-cotton blended fabric. FIG. 3 is a diagram of a thermally transferred sample of a nylon fabric according to Example 3.

### Example 4

The thermal transfer steps for the nylon fabric in this example are as follows:
1) printing a designed pattern on a thermal transfer paper with a digital printer, so as to obtain the thermal transfer paper having the pattern;
2) weighing 3 g 1-naphthoic acid and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.
3) attaching the heat transfer paper having the pattern in step 1) to the modified nylon fabric in step 2), and then thermally transferring under the conditions of a temperature of 220° C., a time of 20 s and a transfer printing pressure of 0.5 MPa, so as to obtain a blended fabric after thermal transfer;

In this case, the thermal transfer is performed by using a hot-pressing plate, so that the dye of the thermal transfer paper having the pattern is sublimated onto the treated polyester-cotton blended fabric. FIG. 4 is a diagram of a thermally transferred sample of a nylon fabric according to Example 4.

### Example 5

The thermal transfer steps for the nylon fabric in this example are as follows:
printing a designed pattern on a thermal transfer paper with a digital printer, so as to obtain the thermal transfer paper having the pattern;
weighing 3 g Compound 1 and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.

In this case, the structural formula of Compound 1 is:

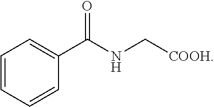 [SMILES: O=C(O)CNC(=O)c1ccccc1]

3) attaching the heat transfer paper having the pattern in step 1) to the modified nylon fabric in step 2), and then thermally transferring under the conditions of a temperature of 220° C., a time of 20 s and a transfer printing pressure of 0.15 MPa, so as to obtain a blended fabric after thermal transfer;

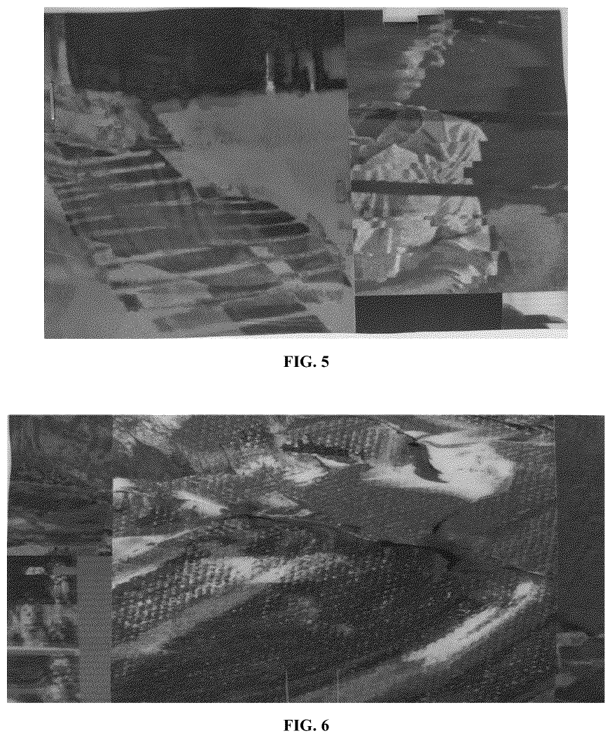

In this case, the thermal transfer is performed by using a hot pressing plate, so that the dye of the thermal transfer paper having the pattern is sublimated onto the treated polyester-cotton blended fabric. FIG. 5 is a diagram of a thermally transferred sample of a nylon fabric according to Example 5.

### Example 6

The thermal transfer steps for the nylon fabric in this example are as follows:
printing a designed pattern on a thermal transfer paper with a digital printer, so as to obtain the thermal transfer paper having the pattern;
weighing 3 g Compound 2 and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.

In this case, the structural formula of Compound 2 is:

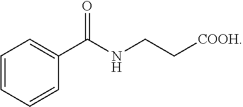 [SMILES: O=C(O)CCNC(=O)c1ccccc1]

3) attaching the heat transfer paper having the pattern in step 1) to the modified nylon fabric in step 2), and then thermally transferring under the conditions of a temperature of 220° C., a time of 20 s and a transfer printing pressure of 0.3 MPa, so as to obtain a blended fabric after thermal transfer;

In this case, the thermal transfer is performed by using a hot pressing plate, so that the dye of the thermal transfer paper having the pattern is sublimated onto the treated polyester-cotton blended fabric. FIG. 6 is a diagram of a thermally transferred sample of a nylon fabric according to Example 6.

### Example 7

The thermal transfer steps for the nylon fabric in this example are as follows:
printing a designed pattern on a thermal transfer paper with a digital printer, so as to obtain the thermal transfer paper having the pattern;
weighing 3 g Compound 3 and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.

In this case, the structural formula of Compound 3 is:

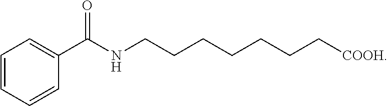 [SMILES: O=C(O)CCCCCCCNC(=O)c1ccccc1]

3) attaching the heat transfer paper having the pattern in step 1) to the modified nylon fabric in step 2), and then thermally transferring under the conditions of a temperature of 220° C., a time of 20 s and a transfer printing pressure of 0.3 MPa, so as to obtain a blended fabric after thermal transfer;

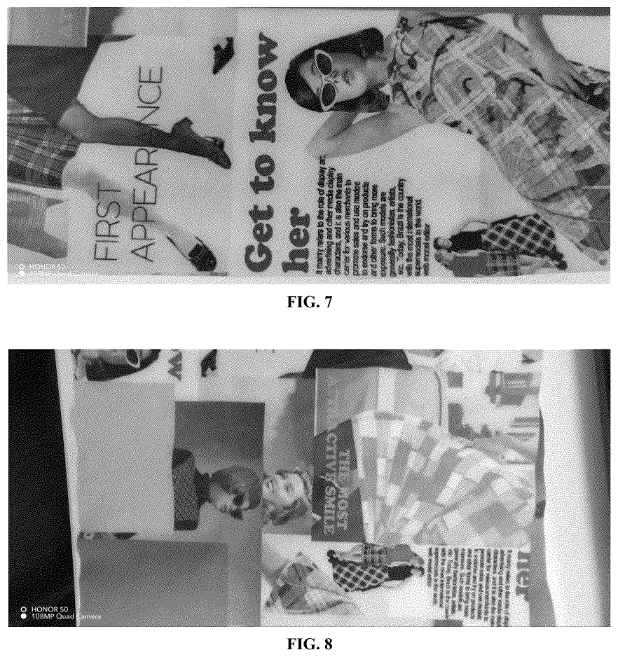

In this case, the thermal transfer is performed by using a hot pressing plate, so that the dye of the thermal transfer paper having the pattern is sublimated onto the treated polyester-cotton blended fabric. FIG. 7 is a diagram of a thermally transferred sample of a nylon fabric according to Example 7.

### Example 8

The thermal transfer steps for the nylon fabric in this example are as follows:
printing a designed pattern on a thermal transfer paper with a digital printer, so as to obtain the thermal transfer paper having the pattern;
weighing 3 g Compound 4 and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.

In this case, the structural formula of Compound 4 is:

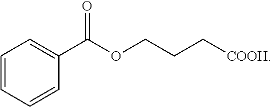 [SMILES: O=C(O)CCCOC(=O)c1ccccc1]

3) attaching the heat transfer paper having the pattern in step 1) to the modified nylon fabric in step 2), and then thermally transferring under the conditions of a temperature of 220° C., a time of 20 s and a transfer printing pressure of 0.35 MPa, so as to obtain a blended fabric after thermal transfer;

In this case, the thermal transfer is performed by using a hot pressing plate, so that the dye of the thermal transfer paper having the pattern is sublimated onto the treated polyester-cotton blended fabric. FIG. 8 is a diagram of a thermally transferred sample of a nylon fabric according to Example 8.

### Example 9

The thermal transfer steps for the nylon fabric in this example are as follows:
printing a designed pattern on a thermal transfer paper with a digital printer, so as to obtain the thermal transfer paper having the pattern;
weighing 3 g Compound 5 and 99 g water in a dyeing pot, and adjusting the pH to 4.5 with acetic acid. 10 g nylon knitted fabric was weighed and placed therein, and the dyeing pot was used for modifying at 98° C. for 50 minutes. After the modifying, the modifier was poured out, and then 100 mL of water was added, the temperature was raised to 60° C., washed twice with water, the nylon fabric was taken out, and dried at 80° C.

In this case, the structural formula of Compound 5 is:

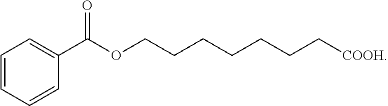 [SMILES: O=C(O)CCCCCCCOC(=O)c1ccccc1]

3) attaching the heat transfer paper having the pattern in step 1) to the modified nylon fabric in step 2), and then thermally transferring under the conditions of a temperature of 220° C., a time of 20 s and a transfer printing pressure of 0.45 MPa, so as to obtain a blended fabric after thermal transfer.

In this case, the thermal transfer is performed by using a hot pressing plate, so that the dye of the thermal transfer paper having the pattern is sublimated onto the treated polyester-cotton blended fabric. FIG. 9 is a diagram of a thermally transferred sample of a nylon fabric according to Example 9.

### Example 10, Comparative Example

This comparative example provides a thermal transfer method for blended fabrics, this method differs from Example 1 and Example 2 in that it does not include the step of treating the nylon fabric with the modifier. This method specifically includes the following steps:
1) printing a designed pattern on a thermal transfer paper with a digital printer, so as to obtain the thermal transfer paper having the pattern;
2) attaching the heat transfer paper having the pattern in step 1) to the nylon fabric, and then thermally transferring under the conditions of a temperature of 220° C., a time of 20 s and a transfer printing pressure of 0.35 MPa, so as to obtain a blended fabric after thermal transfer.

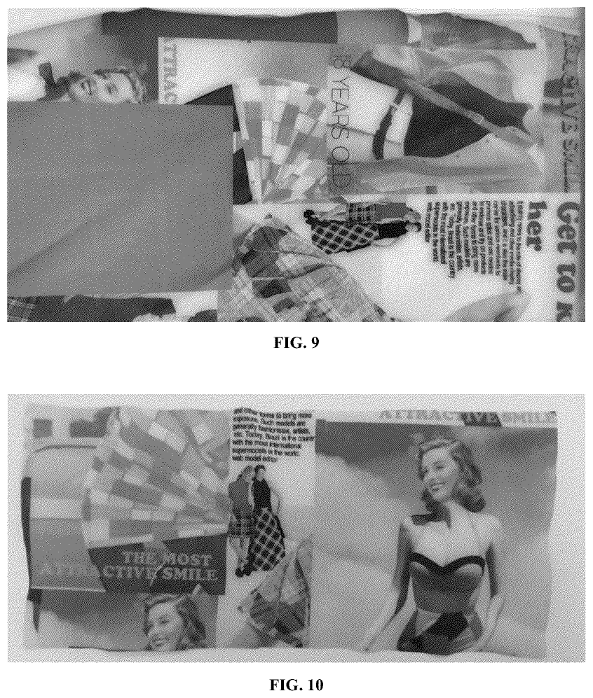

In this case, the thermal transfer is performed by using a hot pressing plate, so that the dye of the thermal transfer paper having the pattern is sublimated onto the treated polyester-cotton blended fabric. FIG. 10 is a diagram of a thermally transferred sample of a nylon fabric according to this Comparative Example.

Performance Test

Color fastness and washing resistance tests were carried out on the nylon fabrics after thermal transfer in Examples 1-9 and Example 10 (Comparative Example), wherein grades of the color fastness to rubbing were obtained by testing white fabrics in accordance with the ISO 105-X12:2016 standard “Textiles—Tests for color fastness—Part X12: Color fastness to rubbing”; grades of the color fastness to water were obtained in accordance with the GB/T 5713-2013 national standard “Textiles—Tests for color fastness—Color fastness to water”. Table 1 shows test results of the color fastness and the washing resistance of the blended fabrics after thermal transfer. The higher the value in Table 1 indicates the better the color fastness of the blended fabric after thermal transfer.

TABLE 1
Test results of the color fastness and the washing resistance of the blended fabrics after thermal transfer

| | | | | | | | | | | | Exam- |
|---|---|---|---|---|---|---|---|---|---|---|---|
| | | | | | | | | | | | ple 10 |
| | | | | | | | | | | | Compar- |
| | | | | | | | | | | | ative |
| | | Exam- | Exam- | Exam- | Exam- | Exam- | Exam- | Exam- | Exam- | Exam- | Exam- |
| Test items | | ple 1 | ple 2 | ple 3 | ple 4 | ple 5 | ple 6 | ple 7 | ple 8 | ple 9 | ple |
| Specification of the | | Nylon-6 | Nylon-6 | Nylon-6 | Nylon-6 | Nylon-66 | Nylon-66 | Nylon-66 | Nylon-66 | Nylon-66 | Nylon-66 |
| fabric to be tested | | | | | | | | | | | |
| Grade of the | Dry rubbing | 4-5 | 4-5 | 4-5 | 4-5 | 4-5 | 4-5 | 4-5 | 4-5 | 4-5 | 4-5 |
| color fastness | Wet rubbing | 4 | 4 | 3.5 | 4 | 4 | 3.5 | 4 | 4 | 4 | 2-3 |
| to rubbing | | | | | | | | | | | |
| Grade of the | Self-staining | 4 | 4 | 4 | 4 | 4 | 4 | 4 | 4 | 4 | 2-3 |
| washing | Cotton-staining | 4 | 4 | 4 | 4 | 4 | 4 | 4 | 4 | 4 | 3-4 |
| resistance | Nylon-staining | 4 | 4 | 4 | 4 | 4 | 4 | 4 | 4 | 4 | 2-3 |
| | Polyester-staining | 4 | 4 | 4 | 4 | 4 | 4 | 4 | 4 | 4 | 4 |
| | Acrylic | 4-5 | 4-5 | 4-5 | 4-5 | 4-5 | 4-5 | 4-5 | 4-5 | 4-5 | 4-5 |
| | fiber-staining | | | | | | | | | | |
| | Acrylic fiber | 4 | 4 | 4 | 4 | 4 | 4 | 4 | 4 | 4 | 2-3 |

It can be seen from Table 1 and FIG. 1-10 that the nylon fabric treated with the modifier can be a printed fabric with bright color, complete pattern, high color fastness and washing resistance by simple thermal transfer processing. However, the nylon fabric which is not treated with the modifier has problems such as poor color fastness, dull and gray fabric color, and poor washing resistance.

The above embodiments are preferred embodiments of the present invention, but the embodiments of the present invention are not limited by the above embodiments. Any other changes, modifications, substitutions, combinations, and simplifications that do not deviate from the spirit and principle of the present invention should be regarded as equivalent alternatives and are included in the protection scope of the present invention.

Accordingly the examples set forth above are provided to give those of ordinary skill in the art a complete disclosure and description of how to make and use the embodiments of the reactive digital printing method of the disclosure, and related materials, compositions, and systems, and are not intended to limit the scope of what the inventors regard as their disclosure. Modifications of the above-described modes for carrying out the disclosure that are obvious to persons of skill in the art are intended to be within the scope of the following claims. All patents and publications mentioned in the specification are indicative of the levels of skill of those skilled in the art to which the disclosure pertains.

The entire disclosure of each document cited (including patents, patent applications, journal articles, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually.

It is to be understood that the disclosures are not limited to particular compositions materials, or biological systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

Unless otherwise indicated, the disclosure is not limited to specific reactants, substituents, catalysts, reaction conditions, or the like, as such may vary. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Thus, for example, reference to “a polymer” includes a single polymer as well as a combination or mixture of two or more polymers, reference to “a substituent” encompasses a single substituent as well as two or more substituents, and the like.

As used in the specification and the appended claims, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

Although any methods and materials similar or equivalent to those described herein can be used in the practice for testing of the specific examples, additional appropriate materials and methods are described herein.

A number of embodiments of the disclosure have been described. Nevertheless, it will be understood that various modifications may be made without departing from the spirit and scope of the present disclosure. Accordingly, other embodiments are within the scope of the following claims.

### REFERENCES

ADDIN EN.REFLIST 1. Wikipedia-textile. Textile. 2022; Available from: en.wikipedia.org/wiki/Textile.
2. Wikipedia-textile-printing. Textile printing. 2022; Available from: en.wikipedia.org/wiki/Textile_printing.
3. Wikipedia, F. Fiber. 2023; Available from: en.wikipedia.org/wiki/Fiber.
4. Wikipedia, Y., Yarn. 2023; Available from en.wikipedia.org/wiki/Yarn.
5. Fiber, W.-N. 2023; Available from: en.wikipedia.org/wiki/Natural_fiber.
6. fiber, W.-s., 2023.
7. Paper, W. T. 2023; Available from: en.wikipedia.org/wiki/Transfer_paper.
8. Wikipedia-ink. Ink. 2022; Available from: en.wikipedia.org/wiki/Ink.
9. Wikipedia-dye. Dye. 2022; Available from: en.wikipedia.org/wiki/Dye.

1. A thermal transfer method for fabrics, comprising
providing a fabric having a molecular structure not comprising a benzene ring and presenting amino groups and contacting the fabric with a modifying solution comprising modifier selected from the group consisting of benzoic acid, naphthoic acid and a compound represented by Formula (I); 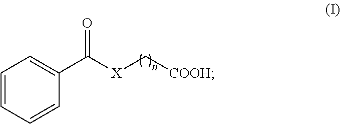
in which X is selected from O or NH, and n is a positive integer selected from 1-10, wherein the contacting is performed to obtain modified fabric before performing a thermal pressure treatment.

2. The terminal transfer method of claim 1, wherein the modifying is performed
modifying a fabric with the modifier in a modifying solution to obtain modified fabric; and the method further comprises
attaching a heat transfer paper having a pattern to the modified fabric, and then performing a thermal pressure treatment on the modified fabric with the attached paper.

3. The thermal transfer method for fabrics according to claim 1, wherein a solvent for the modifier in the modifying solution is selected from the group consisting of water, ethanol, ethyl acetate, N,N-dimethylformamide, and N,N-dimethylacetamide or any combination thereof.

4. The thermal transfer method for fabrics according to claim 3, wherein an amount of the modifier is from 5% o.m.f to 40% o.m.f; and a bath ratio of the modifying solution is from 1:5 to 1:20.

5. The thermal transfer method for fabrics according to claim 3, wherein a pH value of the modifying solution is 3-6.

6. The thermal transfer method for fabrics according to claim 1, wherein a temperature of the modifying is 50° C. to 120° C., and a time of the modifying is 20 mins to 100 mins.

7. The thermal transfer method for fabrics according to claim 1, wherein the modifying further comprises washing the modified fabric.

8. The thermal transfer method for fabrics according to claim 1, wherein a temperature of the thermal pressure treatment is 200° C. to 230° C., and a time of the thermal pressure treatment is 10 s to 30 s.

9. A method for fabric transfer printing, the method comprising the steps of the thermal transfer method for fabrics according to claim 1.

10. A thermal transfer system for thermal treatment of fabrics, the system comprising a fabric having a molecular structure which does not include benzene and presents terminal amino groups, and a modifier selected from the group consisting of benzoic acid, naphthoic acid and a compound represented by Formula (I); 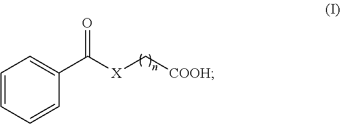
in which X is selected from O or NH, and n is a positive integer selected from 1-10.

11. A printed fabric prepared by the thermal transfer method for fabrics according to claim 1.

12. A fabric item comprising the printed fabric of claim 11.
